(19) United States
(12) Patent Application Publication
(10) Pub. No.: US 2019/0031175 A1
(43) Pub. Date: Jan. 31, 2019

(54) HEATING CONTROL METHOD OF HYBRID VEHICLE

(71) Applicants: Hyundai Motor Company, Seoul (KR); Kia Motors Corporation, Seoul (KR)

(72) Inventors: Chun Hyuk Lee, Suwon (KR); Kyoung Cheol Oh, Suwon (KR); Dong Jin Sohn, Pyeongtaek (KR); Yong Hoon Lee, Incheon (KR); In Eok Cho, Incheon (KR); Dong Jun Shin, Hwaseong (KR); Jee Wook Huh, Bucheon (KR)

(21) Appl. No.: 15/830,911

(22) Filed: Dec. 4, 2017

(30) Foreign Application Priority Data
Jul. 25, 2017 (KR) 10-2017-0093857

(51) Int. Cl. B60W 20/12; F02D 41/06; B60W 10/06

(52) U.S. Cl. CPC B60W 20/12; F02D 41/062; B60W 10/06; F02D 2200/702; Y10S 903/905; B60W 2550/402; B60W 2710/0688; B60W 2550/22; B60W 2710/0644; F02D 2200/701

(57) ABSTRACT

A heating control method of a hybrid vehicle controls engine driving for heating or revolutions per minute (RPM) of an engine according to whether the engine is started in a state in which navigation information is received to actively control a heating value of the engine and to improve fuel efficiency on an actual road in cold weather conditions, and for controlling the RPM of the engine to an appropriate RPM to smoothly recharge a battery with a high voltage through a hybrid starter generator (HSG).

### CROSS-REFERENCE TO RELATED APPLICATION

This application claims under 35 U.S.C. § 119(a) the benefit of Korean Patent Application No. 10-2017-0093857 filed on Jul. 25, 2017, the entire contents of which are incorporated herein by reference.

### BACKGROUND

### (a) Technical Field

The present disclosure relates to a heating control method of a hybrid vehicle, more particularly, to a heating control method for actively controlling an engine heating value for heating using navigation information to improve fuel efficiency.

### (b) Description of the Related Art

A hybrid vehicle, including a plug-in hybrid vehicle or the like, is an eco-friendly vehicle that is driven using power of an electric motor without engine driving in a low speed section or a constant speed section and advantageously improves fuel efficiency as well as reduces exhaust gas compared with a general internal combustion engine vehicle.

When heating in cold weather conditions (e.g., winter) is required while driving such a hybrid vehicle, an engine needs to be started to ensure a heat source for heating up to a predetermined cooling water temperature condition irrespective of a vehicle speed and a driving condition in order to satisfy heating performance, and thus, fuel efficiency in cold weather conditions (e.g., winter) is disadvantageously lowered compared with warm conditions (e.g., summer).

A conventional heating operating procedure of a hybrid vehicle will be described below with reference to FIG. 1. First, while a hybrid vehicle is driven in an electric vehicle (EV) mode or a hybrid electric vehicle (HEV) mode (S101), whether a heating request is made may be determined (S102).

Accordingly, when a driver makes a heating request of turning on a heating switch, a full automatic temperature controller (F.A.T.C.) issues an engine turn-on command to ensure a heat source for heating.

In particular, an engine cooling water temperature light for heating is equal to or less than a reference value during driving in an EV mode, and thus, the F.A.T.C. issues an engine turn-on command, and even if an HEV mode in which an engine is driven is changed to an EV mode, when a value indicated by the engine cooling water temperature light is equal to or less than a reference value, the F.A.T.C. issues an engine turn-on command

Then, an engine is started, and simultaneously is maintained in an idle state according to the engine turn-on command of the F.A.T.C., and thus, a heat source for heating may be ensured, e.g., the engine cooling water temperature may be increased to a reference value or more (S103).

In this case, an engine starting RPM for heating may be set according to an outdoor temperature, and for example, an outdoor temperature may be compared with a reference value (S104), when the outdoor temperature is less than a reference value (x), control of increasing engine revolutions per minute (RPM) to RPM “A” may be performed (S105), and when the outdoor temperature is equal to or greater than the reference value, control of reducing an engine RPM to RPM “B” lower than RPM “A” may be performed (S106).

However, there is a problem in that the aforementioned conventional heating control method results in reduced fuel efficiency as an engine is started to ensure a heat source for heating irrespective of a driving load and condition of a vehicle. In particular, there is a problem in that, when an engine starting command for heating is issued in a stationary state, fuel efficiency is degraded due to an increase in fuel consumption, and also, a vehicle occupant may sense a difference due to sudden starting of an engine, thereby degrading product quality.

To reduce unnecessary energy loss during engine starting for heating, power of the engine is increased to recharge a high-voltage battery through a hybrid starter generator (HSG).

In this regard, average vehicle speed in a current state of a vehicle is determined and respective amounts of battery recharging are determined with respect to low speed/middle speed/high speed regions. However, since a computational time is required to determine accurate vehicle speed, a current amount of recharging is determined based on a past value, and thus, an engine is driven with an RPM that is equal to or greater than an RPM required for actual recharging, thereby reducing fuel efficiency.

### SUMMARY

In one aspect, the present disclosure provides a heating control method of a hybrid vehicle for controlling engine driving for heating or controlling engine revolutions per minute (RPM) according to whether an engine is started in a state in which navigation information is received to actively control a heating value of the engine and to improve fuel efficiency on an actual road in cold weather conditions (e.g., winter), and for controlling the engine RPM to an appropriate RPM to smoothly recharge a battery with a high voltage through a hybrid starter generator (HSG).

In a preferred embodiment, a heating control method of a hybrid vehicle, the method includes determining whether navigation information is received, upon receiving the navigation information, determining whether an engine is started, when the engine is not started, determining whether a heating request is made, and when the heating request is made, delaying engine starting for heating or for a predetermined time period based on traffic flow information, a distance to a destination, and road conditions, included in the navigation information.

The delaying of the engine starting for heating may include delaying the engine starting for heating for a predetermined time period when the traffic flow is smooth and the distance to the destination is less than a reference value, and immediately performing the engine starting for heating when the distance is equal to or greater than the reference value.

The delaying of the engine starting for heating may include delaying engine starting for a predetermined time period when the traffic flow is smooth and a highway is present within a predetermined distance to the destination, and immediately performing the engine starting for heating when the highway is not present.

The delaying of the engine starting for heating may include delaying engine starting for a predetermined time period when the traffic flow is smooth and the vehicle is being driven on a front uphill road during driving to the destination, and if not, immediately performing the engine starting for heating.

The delaying of the engine starting for heating may include delaying engine starting for a predetermined period time when the traffic flow is smooth and a traffic light indicates to stop during driving to the destination, and immediately performing the engine starting for heating when the traffic light indicates go. The method may further include, between the determining of whether the heating request is made and the delaying of the engine starting for heating, immediately performing engine starting when an outdoor temperature and a reference temperature are compared and the outdoor temperature is less than the reference temperature, and performing the delaying of the engine starting for heating when the outdoor temperature is equal to or greater than the reference temperature.

In another preferred embodiment, the method may further include, as a result of the determining of whether the engine is started, when the engine is started, adjusting engine revolutions per minute (RPM) for recharging a high-voltage battery based on the traffic flow information, the distance to the destination, and the road conditions, included in the navigation information.

The adjusting of the engine RPM may include performing control of lowering the engine RPM to a predetermined level when the traffic flow is smooth and the distance to the destination is less than the reference value.

The adjusting of the engine RPM may include performing control of lowering the engine RPM to a predetermined level when the traffic flow is smooth and a highway is present within a predetermined distance to the destination.

The adjusting of the engine RPM may include performing control of lowering the engine RPM to a predetermined level when the traffic flow is smooth and the vehicle is being driven on a front uphill road during driving to the destination. The adjusting of the engine RPM may include performing control of maintaining original engine RPM without lowering the engine RPM when the traffic flow is smooth and an intersection is present during driving to the destination.

In another aspect, the present disclosure provides a non-transitory computer readable medium containing program instructions executed by a processor, the computer readable medium including: program instructions that determine whether navigation information is received; program instructions that, upon receiving the navigation information, determine whether an engine is started; program instructions that, when the engine is not started, determine whether a heating request is made; and program instructions that, when the heating request is made, delay engine starting for heating or for a predetermined time period based on traffic flow information, a distance to a destination, and road conditions, included in the navigation information.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 (RELATED ART) is a flowchart showing a conventional heating control procedure of a hybrid vehicle; and

FIGS. 2 and 3 are flowcharts showing a heating control method of a hybrid vehicle according to the present disclosure.

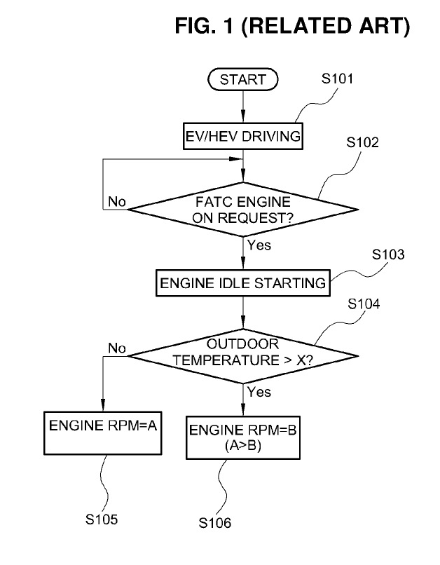

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will be made in detail to various embodiments of the present disclosure, examples of which are illustrated in the accompanying drawings and described below.

According to the present disclosure, engine driving for heating may be controlled or engine revolutions per minute (RPM) for battery recharging may be controlled using navigation information, and thus, a heating value of an engine may be actively controlled to improve fuel efficiency on an actual road in cold weather conditions (e.g., winter), and the engine RPM may be controlled to an appropriate RPM to smoothly recharge a battery with a high voltage through a hybrid starter generator (HSG).

To this end, a heating control method of a hybrid vehicle according to the present disclosure may include: i) determining whether navigation information is received; ii) upon receiving the navigation information, determining whether an engine is started; iii) when the engine is not started, determining whether a heating request is made; and iv) when the heating request is made, delaying engine starting for heating or for a predetermined time period based on traffic flow information, a distance to a destination, and road conditions, included in the navigation information.

In this case, with regard to entities for performing the respective operations, operation i) may be performed by receiving the navigation information by a full automatic temperature controller (F.A.T.C.) from a navigation device, operations ii) and iii) may also be performed by the F.A.T.C. that receives information on whether an engine is started by an engine controller, and operation iv) may be performed by transmitting a command to the engine controller by the F.A.T.C. that receives the navigation information.

The heating control method of a hybrid vehicle according to the present disclosure will be described stepwise in more detail.

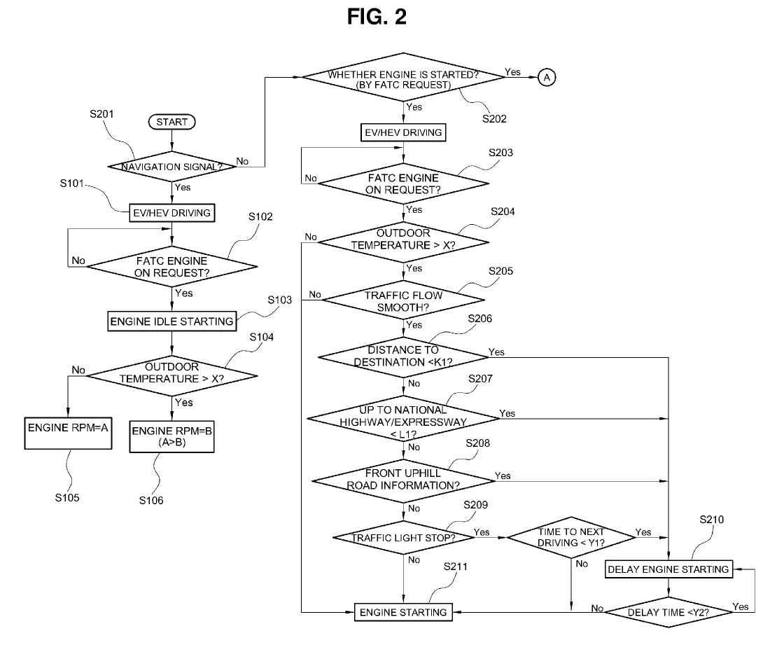

FIG. 2 is a flowchart showing an example of a heating control method of a hybrid vehicle according to the present disclosure.

First, whether navigation information is received during driving of a hybrid vehicle may be determined (S201).

In this case, when the navigation information is not received, operations S101 to S106, as the conventional heating control procedure described in the above background section may be performed.

On the other hand, when the navigation information is received, whether an engine is started may be determined (S202).

Then, upon determining that the engine is not started, whether a heating request is made may be determined (S203).

That is, whether a driver makes a heating request of turning on a heating switch may be determined.

Then, when the heating request is made, a series of heating control procedures may be performed to delay engine starting for heating or for a predetermined time period based on traffic flow information, a distance to a destination, and road conditions, included in the navigation information.

In particular, prior to the series of heating control procedures using the navigation information, an outdoor temperature and a reference temperature are compared (S204), when the outdoor temperature is less than the reference temperature, heating in cold weather conditions (e.g., winter) is determined to be required and control of immediately starting an engine for ensuring a heat source for heating may be performed (S211), and when the outdoor temperature is equal to or greater than the reference temperature, the series of heating control procedures using the navigation information may be begun.

As an example of the series of heating control procedures, whether a traffic flow state is smooth may be determined based on the navigation information (S205), a remaining distance to a destination may be compared with a reference value (K1) (S206), when a traffic flow state is smooth and the distance to the destination is less than the reference value (K1), control of delaying engine starting for heating for a predetermined time period may be performed (S210), and when the distance to the destination is equal to or greater than the reference value, control of immediately starting the engine for heating may be performed (S211).

In particular, in a state in which the traffic flow state is smooth, when the distance to the destination is less than the reference value (K1), the destination on a setting path of a navigation device and the current location are adjacent to each other and the possibility that a vehicle is turned off (KEY OFF) upon arriving at the destination is high, and thus, even if an engine starting (ON) request for satisfying heating performance is made, control of delaying engine starting for a predetermined time period until a vehicle arrives at the destination may be performed (S210) to prevent unnecessary fuel consumption, thereby improving fuel efficiency.

Even if a vehicle arrives at the destination, when the vehicle is maintained in a vehicle starting-on (KEY-ON) state, an engine is driven after a predetermined time period elapses to ensure a heat source for heating.

On the other hand, in a state in which the traffic state is smooth, when the distance to the destination is equal to or greater than the reference value (K1), a destination on a set path of a navigation device is far away from the current location and it is necessary to immediately perform indoor heating according to a heating request, and thus, control of immediately starting the engine for heating may be performed (S211) to easily ensure a heat source for heating.

As another example of the series of heating control procedures, whether a traffic flow state is smooth may be determined based on the navigation information (S205), whether a highway (e.g., an interstate highway, divided highway, toll road, etc.) is present within a predetermined distance to the destination may be determined (S207), when the traffic flow state is smooth and the highway is present within a predetermined distance (L1) to the destination, control of delaying engine starting for heating for a predetermined time period may be performed (S210), and when the highway is not present, control of immediately starting the engine for heating may be performed (S211).

In particular, when an engine starting request is made during electric motor driving (EV), if traffic flow on a driving path is smooth and a highway on a navigation setting path is expected, engine starting may be delayed because HEV driving that uses engine starting and power of an electric motor is inevitably guided to increase vehicle speed on the highway and it is possible to rapidly ensure a heat source via engine starting.

As another example of the series of heating control procedures, whether a traffic flow state is smooth may be determined according to the navigation information (S205), whether a front uphill path is present during driving to the destination may be determined (S208), when the traffic flow is smooth and the front uphill path is determined to be present within a predetermined distance, control of delaying engine starting for heating for a predetermined time period may be performed (S210), and when the front uphill path is not present within the predetermined distance, control of immediately starting the engine for heating may be performed (S211).

In this case, a frequency of HEV driving that uses engine starting and power of an electric motor during driving on an uphill path may be increased, and thus, when the traffic flow is smooth and the front uphill path is present within a predetermined distance, engine starting may be delayed at a predetermined distance from a point where front uphill path driving is started, thereby improving fuel efficiency.

As another example of the series of heating control procedures, whether the traffic flow state is smooth may be determined based on the navigation information (S205), whether a traffic light indicates to stop may be determined during driving to the destination (S209), when the traffic flow is smooth and the traffic light indicates to stop during driving to the destination, control of delaying engine starting for heating for a predetermined time period may be performed (S210), and when the traffic light indicates to go, control of immediately starting the engine for heating may be performed (S211).

For example, when an engine starting (ON) request is made for heating during stop in the case of stop indicated by a traffic light, engine starting may be delayed with reference to a time period to a next starting signal and HEV driving may be guided in the case of a next starting signal to increase a cooling water temperature of an engine, thereby sufficiently ensuring a heat source required for heating.

Engine starting for heating during a stop may be delayed, and thus, a vehicle occupant may be prevented from feeling a sense of difference in the case of engine starting for heating during a stop.

For example, the present disclosure may overcome a problem in that a vehicle occupant has a sense of difference because noise and vibration that are not expected by the consumer are generated during engine starting for heating in a stop state such as waiting at a stoplight.

In addition, when a vehicle enters a traffic congestion section on an expressway, if a point at which traffic congestion is released and a current location are adjacent to each other, control of delaying engine starring for heating may be further performed using road information and traffic information during current driving, which are included in the navigation information, with reference to a distance to the point at which traffic congestion is released.

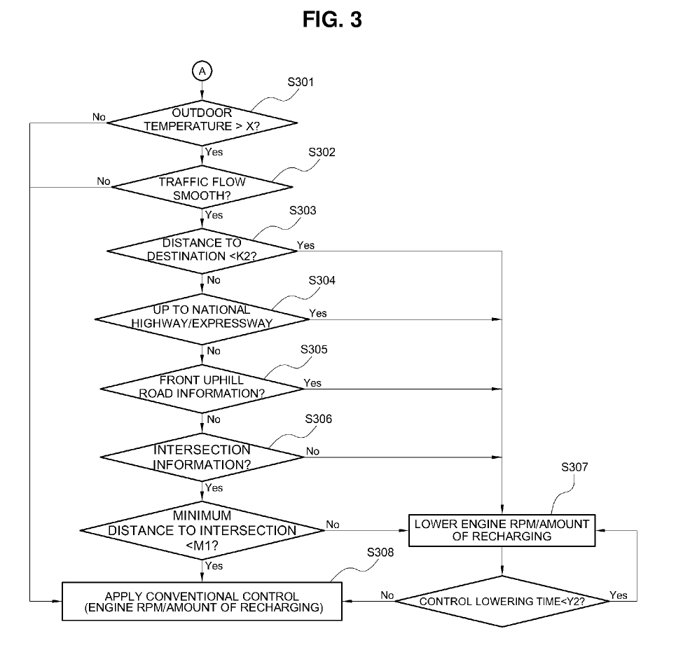

As a determination result of operation 5202, even if the navigation information is received, when it is determined that engine starting for heating is already performed, engine RPM control of maintaining or reducing an engine RPM may be further performed to improve fuel efficiency and adjust an amount of recharging based on traffic flow information, a distance to a destination, and road conditions, which are included in the navigation information, which will be described below with reference to FIG. 3.

First, as the determination result of operation S202, even if the navigation information is received, when it is determined that engine starting for heating is already performed, an outdoor temperature and a reference temperature may be compared (S301).

As a comparison result, when the outdoor temperature is less than the reference temperature, heating in cold weather conditions (e.g., winter) may be determined to be maintained and an engine RPM for ensuring a heat source for heating may be maintained at a current level (S308), and when the outdoor temperature is equal to or greater than the reference temperature, an engine RPM control operation using the navigation information may be started.

As an example of the engine RPM control operation using the navigation information, whether the traffic flow state is smooth may be determined based on the navigation information (S302), a remaining distance to a destination may be compared with a reference value (K2) (S303), when the traffic flow is smooth and the distance to the destination is less than the reference value (K2), control of reducing an engine RPM to a predetermined level may be performed (S307), and when the distance is equal to or greater than the reference value (K2), control of maintaining an engine RPM at a current level may be performed (S308).

In more detail, during engine starting (ON) for heating control, an engine RPM (and/or engine torque) may be determined and, in this case, when a current position and a destination are adjacent on a navigation setting path, the engine RPM may be reduced to a predetermined level to ensure a minimum heat source up to the destination, thereby improving fuel efficiency, and revolution of an HSG (which is a kind of generation device connected to an engine crank shaft) may be reduced due to reduction in engine RPM to slightly reduce an amount of battery recharging with high voltage by the HSG. As another example of the engine RPM control operation using the navigation information, whether the traffic flow state is smooth may be determined based on the navigation information (S302), whether a highway (e.g., interstate highway, divided highway, toll road, etc.) is present within a predetermined distance (L2) to the destination may be determined (S304), when the highway is present within the predetermined distance (L2), control of reducing an engine RPM to a predetermined level may be performed (S307), and when the highway is not present, control of maintaining an engine RPM at a current level may be performed (S308).

In particular, when a current location and a start point of a highway are adjacent on a navigation setting path, since a frequency of HEV driving is increased due to middle speed/high speed driving on the highway compared with in city, the possibility that a heat source of an engine is ensured is increased and, thus, when an entrance point of the highway is within a predetermined distance on the navigation setting path, an engine RPM and torque may be lowered as much as possible to ensure a minimum heat source and to, simultaneously, reduce fuel consumption, thereby improving fuel efficiency.

As another example of the engine RPM control operation using the navigation information, whether the traffic flow state is smooth may be determined based on the navigation information (S302), whether a front uphill path is present may be determined (S305), when the traffic flow is smooth and the front uphill path is determined to be present within a predetermined distance, control of reducing an engine RPM to a predetermined level may be performed (S307), and when the front uphill path is not present within the predetermined distance, control of maintaining an engine RPM at a current level may be performed (S308).

In this case, a frequency of HEV driving that uses engine starting and power of an electric motor during driving on an uphill path may be increased and, thus, when the traffic flow is smooth and the front uphill path is present within a predetermined distance, an engine

RPM and torque may be lowered at a predetermined distance from a point where front uphill path driving is started to reduce fuel consumption, thereby improving fuel efficiency.

As another example of the engine RPM control operation using the navigation information, whether the traffic flow state is smooth may be determined based on the navigation information (S302), whether an intersection is present during driving to a destination may be determined (S306), when the traffic flow is smooth and an intersection is not determined to be present within a predetermined distance, control of lowering an engine RPM to a predetermined level may be performed (S307), and when an intersection is present in the predetermined distance, control of maintaining an engine RPM at a current level may be performed (S308).

In particular, an intersection corresponds to road information that causes a vehicle to stop or to reduce speed, and thus, when it is determined that an intersection is not present within a predetermined distance while a traffic flow state is smooth, it is deemed that driving is maintained, and thus, in this case, an engine RPM and torque may be lowered to ensure fuel efficiency as much as possible.

In particular, when a minimum distance to the intersection is less than a reference distance (M1), it may be determined that a vehicle is supposed to pass through the intersection, an engine RPM may not be lowered, and control of maintaining an original engine RPM may be performed.

As such, in a state in which navigation information is received and an engine is not started, engine starting for heating may be controlled based on navigation information, and thus, unnecessary engine starting may be prevented or minimal fuel consumption may be controlled in a heating condition in cold weather conditions (e.g., winter) to improve fuel efficiency on an actual road, and also, in a state in which the navigation information is received and the engine is already started, an engine RPM may be controlled to an appropriate RPM based on the navigation information to minimize fuel consumption, thereby improving fuel efficiency.

Through the above technical solution, the present disclosure may provide the following advantages.

First, in a state in which navigation information is received and an engine is not started, engine starting for heating may be controlled based on the navigation information to actively control a heating value of the engine and, thus, unnecessary engine starting may be prevented or minimum fuel consumption may be controlled in a heating condition in cold weather conditions (e.g., winter) to improve fuel efficiency on an actual road.

Second, a sense of difference at engine starting for heating during a stop may be eased.

For example, the present disclosure may overcome a problem in that a vehicle occupant has a sense of difference because noise and vibration that are not expected by the vehicle occupant are generated during engine starting for heating in a stop state such as waiting at a stoplight.

Third, in a state in which navigation information is received and an engine is started, an engine RPM may be controlled to an appropriate RPM based on the navigation information to smoothly recharge a battery with a high voltage through an HSG, thereby improving fuel efficiency.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A heating control method of a hybrid vehicle, the method comprising:
determining, by a controller, whether navigation information is received;
upon receiving the navigation information, determining, by the controller, whether an engine is started;
when the engine is not started, determining, by the controller, whether a heating request is made; and
when the heating request is made, delaying, by the controller, engine starting for heating or for a predetermined time period based on traffic flow information, a distance to a destination, and road conditions, included in the navigation information.

2. The method of claim 1, wherein the delaying of the engine starting for heating comprises:
delaying the engine starting for heating for the predetermined time period when the traffic flow is smooth and the distance to the destination is less than a reference value; and
immediately performing the engine starting for heating when the distance is equal to or greater than the reference value.

3. The method of claim 1, wherein the delaying of the engine starting for heating comprises:
delaying engine starting for the predetermined time period when the traffic flow is smooth and a highway is present within a predetermined distance to the destination; and
immediately performing the engine starting for heating when the highway is not present.

4. The method of claim 1, wherein the delaying of the engine starting for heating comprises:
delaying engine starting for the predetermined time period when the traffic flow is smooth and the vehicle is being driven on a front uphill road during driving to the destination; and
if not, immediately performing the engine starting for heating.

5. The method of claim 1, wherein the delaying of the engine starting for heating comprises:
delaying engine starting for the predetermined time period when the traffic flow is smooth and a traffic light indicates to stop during driving to the destination; and
immediately performing the engine starting for heating when the traffic light indicates go.

6. The method of claim 1, further comprising:
between the determining of whether the heating request is made and the delaying of the engine starting for heating,
immediately performing engine starting when an outdoor temperature and a reference temperature are compared and the outdoor temperature is less than the reference temperature; and
performing the delaying of the engine starting for heating when the outdoor temperature is equal to or greater than the reference temperature.

7. The method of claim 1, further comprising:
as a result of the determining of whether the engine is started, when the engine is started, adjusting engine revolutions per minute (RPM) for recharging a high-voltage battery based on the traffic flow information, the distance to the destination, and the road conditions, included in the navigation information.

8. The method of claim 7, wherein the adjusting of the engine RPM comprises performing control of lowering the engine RPM to a predetermined level when the traffic flow is smooth and the distance to the destination is less than the reference value.

9. The method of claim 7, wherein the adjusting of the engine RPM comprises performing control of lowering the engine RPM to a predetermined level when the traffic flow is smooth and a highway is present within a predetermined distance to the destination.

10. The method of claim 7, wherein the adjusting of the engine RPM comprises performing control of lowering the engine RPM to a predetermined level when the traffic flow is smooth and the vehicle is being driven on a front uphill road during driving to the destination.

11. The method of claim 7, wherein the adjusting of the engine RPM comprises performing control of maintaining original engine RPM without lowering the engine RPM when the traffic flow is smooth and an intersection is present during driving to the destination.

12. A non-transitory computer readable medium containing program instructions executed by a processor, the computer readable medium comprising:
program instructions that determine whether navigation information is received;
program instructions that, upon receiving the navigation information, determine whether an engine is started;
program instructions that, when the engine is not started, determine whether a heating request is made; and
program instructions that, when the heating request is made, delay engine starting for heating or for a predetermined time period based on traffic flow information, a distance to a destination, and road conditions, included in the navigation information.
